(19) United States
(12) Patent Application Publication
(10) Pub. No.: US 2014/0330618 A1
(43) Pub. Date: Nov. 6, 2014

(54) INTERACTIVE SURVEY SYSTEM

(71) Applicant: Zulimar Corporation Inc., (US)

(72) Inventors: Brian Wong, Richmond Hill (CA); Sharon Wong, Etobicoke (CA)

(21) Appl. No.: 13/875,082

(22) Filed: May 1, 2013

(51) Int. Cl. G06Q 30/02

(52) U.S. Cl. CPC G06Q 30/0203
USPC 705/7.32

(57) ABSTRACT

An on-line interactive survey system in which a server generates a markup document based on questions in a database. The database also includes question logic fields from which the server generates survey logic. The database is organized so that survey logic associated with a first question calls a logic function associated with a second given question, and the logic function calls the survey logic in association with the second question so as to provide a recursive logic chain at least two levels deep. The logic functions may be used to show and/or hide questions. In this manner, surveys can be quickly build and re-used with branching logic intact.

### FIELD OF INVENTION

The invention relates to the field of on-line, browser based, interactive surveys.

### BACKGROUND

The Internet and world wide web protocol has proved to be a useful communication medium for gathering information from and/or for providing information to consumers and/or professionals. The web operates through a generic client/server paradigm in which clients, which run browser software, request documents from a server. The documents are provided to the clients in a marked up language (HTML) and the browser interprets the documents for display on the client. This paradigm is also being increasingly employed with mobile infrastructure such as ‘smart phones’ and ‘tablets’.

The web is quite useful for conducting on-line surveys, in which responses are solicited for a series of questions presented by the survey taker. The responses can be utilized for the purposes of mere information gathering, for example, to assess public opinion about a particular product or service. Alternatively, the survey can be used so that information gathered thereby can be processed in order to make a recommendation, for example, to recommend medication or a treatment plan for a specific patient. In either case, in order to be truly useful in practice the survey should be interactive and dynamic as often the answer to one question leads to a need to ask different subsequent questions as part of the information gathering process.

In addition to the foregoing, the survey taker often needs to develop different surveys. Often, the surveys may be similar to one another in that many (but not all) of the questions are the same or may follow similar sub-patterns. For example, in a medical context, questions regarding age, sex, and previous medical conditions may be common in many surveys.

The prior art has attempted to ameliorate some of these issues. For example, U.S. Pat. No. 7,941,751 to Ebert and U.S. Pat. No. 8,065,609 to Holloway et al. disclose the concept of incorporating simple branching logic in a web-based survey where, depending on the answer to a question, first or second sets of questions may be presented. Ebert describes the use of a graphical controller to enable the survey designer to link a question with subsequent questions and Holloway et al. describes the use of a hash table for recording a branching instruction. Unfortunately, these systems are insufficiently robust in that they do not allow for comprehensive real time changes to the survey in relation to the answers selected or written by the user. For example, the surveys provided these systems are generally linear or sequential in nature. Thus, for instance, if a user is deep into a survey and wants to go back and change an early answer, there is no mechanism for dynamically changing the survey.

Another issue faced by the survey designer is the speed and efficiency by which a survey can be generated. U.S. Pat. No. 7,599,956 to Kirckpatrick et al. discloses the use of a master question database from which survey questions can be re-used in subsequent surveys. This reference suggest that the application code for generating a survey can be generic to all surveys and does not need to be modified. This might be acceptable for simple surveys, but not for those that require any complex branching which conventionally require custom-coding and moot the advantages of master question database.

The survey owner still faces the problem of being able to rapidly and efficiently develop different interactive surveys. Moreover, these surveys need to work across a wide variety of client devices, including smart phones and tablets whose computing power and/or bandwidth connections may be limited.

### SUMMARY

In one aspect, a system is provided for conducting an on-line survey having multiple questions. The system includes a server and at least one client device connectable to the server via a communications network. The server accesses a question database, wherein each question record includes a question text field, a question type field, at least one answer field, and at least one logic field. A subset of the logic fields in the questions records has or references at least one first logic function.

The server, in response to the client device sending a request to conduct an on-line survey, is programmed to retrieve a plurality of the question records from the question database and generate a markup document, corresponding to the information in the retrieved question records, for displaying the survey questions and at least one user answer input per question in a browser. The markup document is configured to call survey logic browser programming instructions in response to user input events. The server also generates the survey logic browser programming instructions based on the at least one logic field from the retrieved question records. The server serves the markup document, the survey logic browser programming instructions and the at least first logic function to a client device.

The question database is organized such that, when generated, the survey logic browser programming instructions associated with a first given question call the at least one first logic function in association with a second given question. The at least one first logic function directly or indirectly calls the survey logic browser programming instructions in association with the second given question so as to provide a recursive logic chain at least two levels deep.

The client device displays the markup document via a client device browser. In execution, the survey logic browser programming instructions associated with the first given question call the at least one first logic function in association with the second given question. The at least one first logic function directly or indirectly calls the survey logic browser programming instructions in association with the second given question so as to provide a recursive logic chain at least two levels deep.

The server preferably serves the markup document and the survey logic browser programming instructions at substantially one time to a given client device so as to eliminate requirement for browser page refreshes.

The question record preferably includes a survey identifier field and the server may retrieve question records from the question database based on a survey identifier transmitted by the client device in the request to conduct the on-line survey. In retrieving question records from the question database, the server may also retrieve additional question records based on question associations in the logic functions stored in the at least one question record logic field.

Each question record may have at least one logic field associated with the question as a whole and at least one logic field associated with each answer field of each question record.

The at least one first logic function may be responsible for hiding or removing a question from the visible browser display in which case the recursive logic chain may hide a plurality of visible questions from the browser display when the user changes an answer to a question. The at least one first logic function may additionally or alternatively be responsible for showing an additional question on the browser display in which case the recursive logic chain may show additional questions on the browser display when the user changes an answer to a question.

Additionally or alternatively, the logic field(s) may include or call a function that processes user answers to a number of questions and generates a visible output based on the answers.

The at least one first logic function may call at least one other logic function which calls the survey logic browser programming instructions.

In other aspect, a method related to the foregoing system is provided.

In yet another aspect, a computer program product is provided for carrying out the server side of the foregoing system.

### BRIEF DESCRIPTION OF DRAWINGS

The foregoing and other aspects of the invention will be more fully appreciated by with reference to the attached drawings, wherein:

FIG. 1 is a system block diagram of a survey generation system;

FIG. 2 is a database schema of a question database;

FIG. 3 is flowchart of a survey rendering process;

FIG. 4 details a portion of the flowchart shown in FIG. 3;

FIG. 5 is a schematic diagram representing an example survey and its desired branching logic;

FIG. 6 shows a snippet of browser programming instructions in pseudo-code form that would be rendered by the survey rendering process of FIG. 4 to provide logic for the survey example depicted in FIG. 5;

FIG. 7 is a browser screen showing the example survey in a first state;

FIG. 8 is a browser screen showing the example survey in a second state after the user has returned to an earlier answered question and changed the selected answer;

FIGS. 9A-9K show records in a question base that correspond to the example survey; and

FIG. 10 shows some predefined functions in javascript form that the survey rendering process in FIG. 4 calls upon.

### DETAILED DESCRIPTION OF PREFERRED EMBODIMENTS

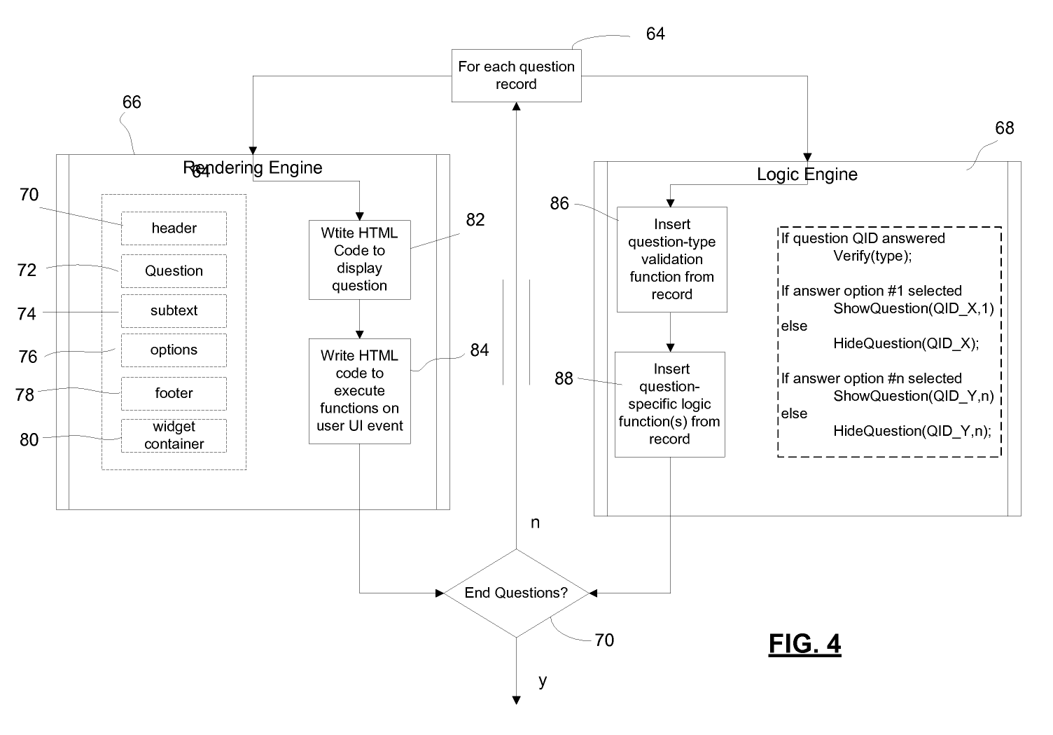

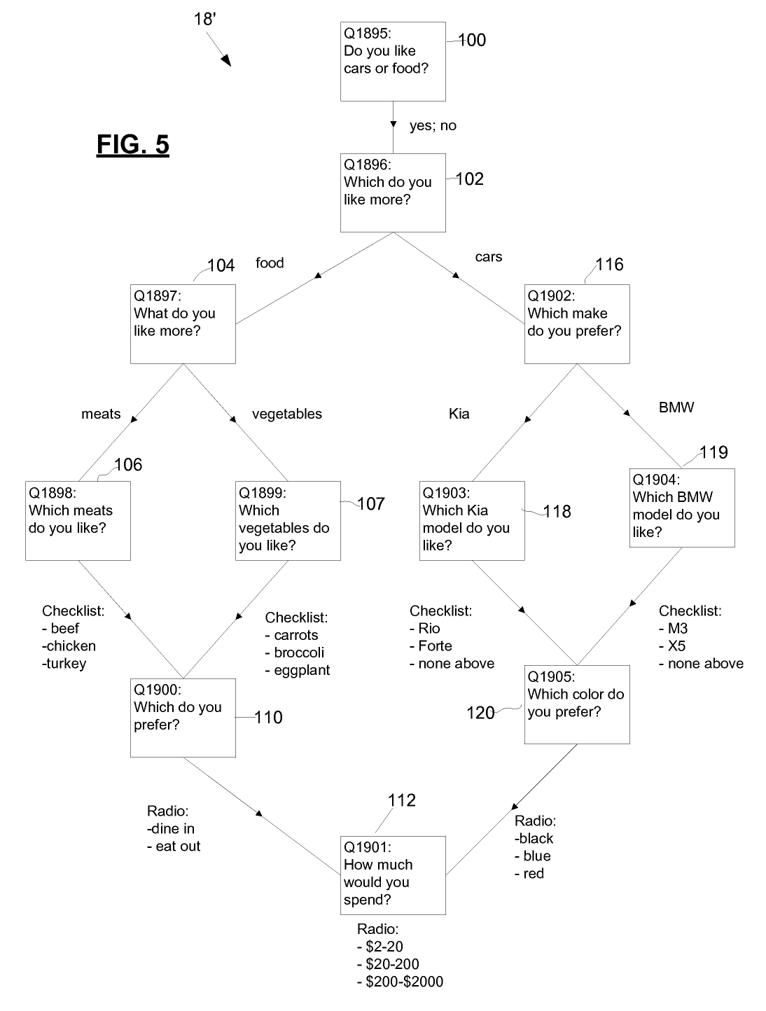

A computer program listing is included at the end of this description, prior to the claims. The computer program listing shows a snippet of browser programming instructions in javascript form that is rendered by the survey rendering process of FIG. 4 to provide logic for the survey example depicted in FIG. 5

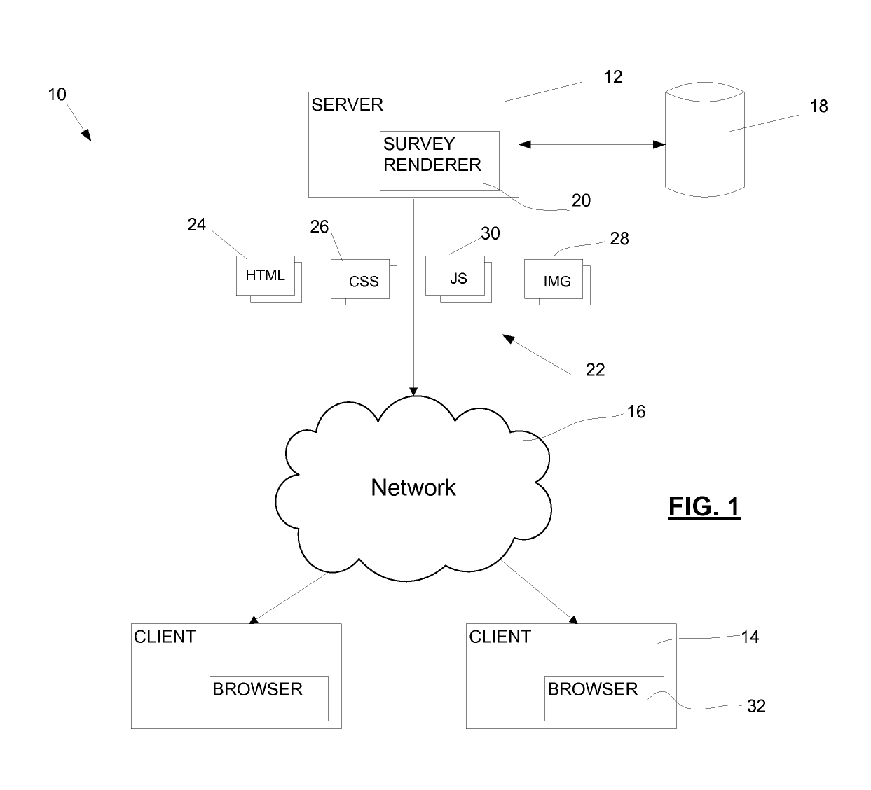

FIG. 1 shows a system level diagram of a web-enabled survey system 10. The system includes a central server 12 that is connected to clients 14 via a network 16 such as the Internet. The server 12 is connected to a question data base 18 from which questions and logic, as described in greater detail below, are accessed and retrieved by a rendering program 20 (which may be written in the PHP programming language) executing on the server 12 to generate a dynamic interactive survey 22. The dynamic survey 22 is preferably generated in the form of a single web page, comprising, as is known in the art, a hypertext markup document 24 (such as an HTML file), a style sheet document 26 (such as CSS file), source material 28 (such as image files) and browser programming instructions 30 (such as javascript files) that are preferably served at one time to the client 14 so as to avoid the need to communicate new or changed questions or other changes to the survey 22 back and forth between the client and the server. This reduces the latency perceived by the user as her or she fills out the survey 22. The client 14 executes a browser 32, as known in the art, which displays and executes the dynamic survey 22, as discussed in greater detail below.

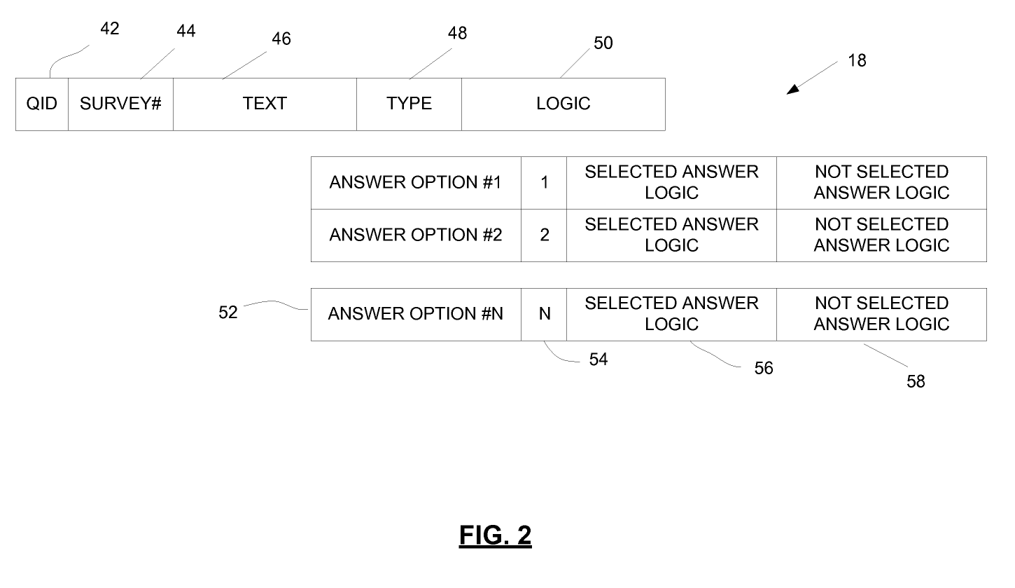

A non-limiting example of the record structure in question base 18 is illustrated in schematic form in FIG. 2 and includes (but is not limited to) the following:
QID 42—question identification number.
Survey#44—indicates whether or not the question should be included in the survey being rendered.
Question_Text 46—the text of the question.
Type 48—specified an enumerated question type based on the format of the answer(s). The permissible answer formats may include: a checkbox list, a date, a dropdown menu, a number, a percentage, a radio button list, a rating, a ranking or free form text box.
Question_Logic 50. Each question may be associated with one or more logic functions that are called when the question is displayed by the browser. The logic functions may be simple branching logic functions associated with each question, as discussed in greater detail below, or more complex applets or micro-programs that require data captured during the survey. This field stores the references to the logic function(s), if any.
Answer_Options 52—Each question may be associated with at least one answer option. With a free form type (such as a Textbox type), there will be one answer option to capture the user answer. In the event the question Type 48 has plural pre-determined optional answers (e.g., checkbox, radio or dropdown types) there is a sub-record for each answer option. Each answer option may also be associated with one or more logic functions. The logic functions may be simple branching logic functions for chaining questions together or selectively enabling/disabling various answer options within the answer option set, as discussed in greater detail below. Alternatively, the logic may provide more complex functionality in the form of an applet or micro-program that is called when the answer option is selected.

Each answer option sub-record includes:
Identifier 54—identifying the option number;
Selected_Logic 56—these are the logic function(s), if any, that are called when the user selects the given answer option; and
Not_Selected_Logic 58—these are the logic function(s), if any, that are called if the user does not select the given answer option.

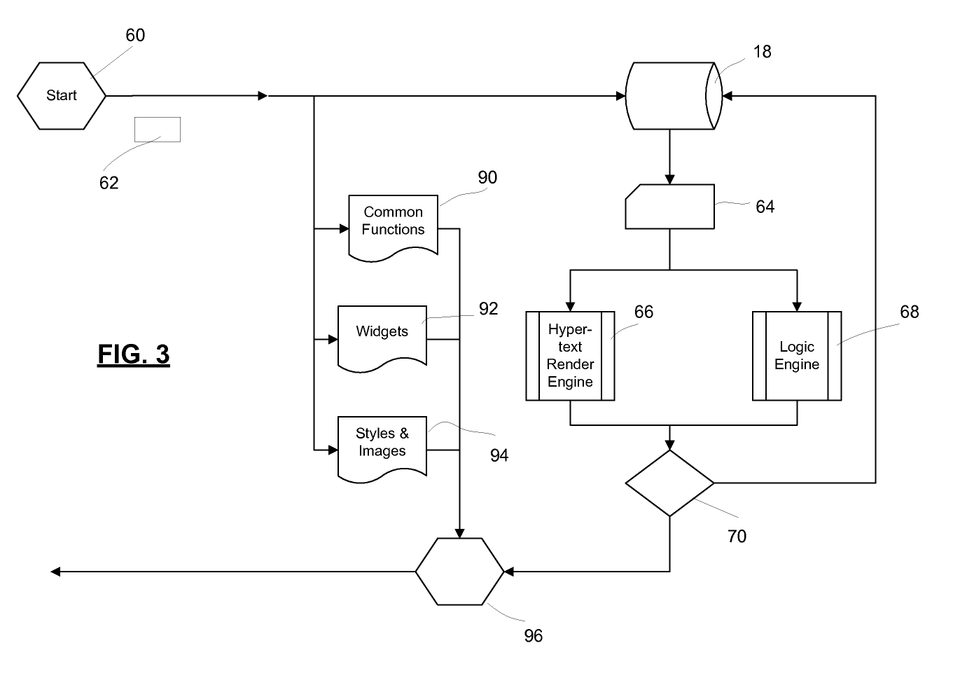

FIG. 3 shows a flow chart of the process executed by the server rendering program 20. The process starts (step 60) in response to a request from the client 14 to conduct a survey. This request can arrive from a variety of sources. For example, the survey owner may have a general web page in which a number of potential surveys are described and the user is requested to select one, in which case a request, along with a survey identifier 62, is communicated to the server. The survey identifier 62 provides a key to retrieve certain questions from the question base 18, as discussed in greater detail below, that are explicitly associated with the requested survey. Step 64 represents the beginning of a loop in which retrieved questions are processed by a rendering engine 66 and a logic engine 68. As discussed in greater detail below, a retrieved question may point to other questions in the question base that are also incorporated into the survey and processed by the rendering and logic engines 66, 68. Step 70 returns control to step 64 until all survey questions have been processed.

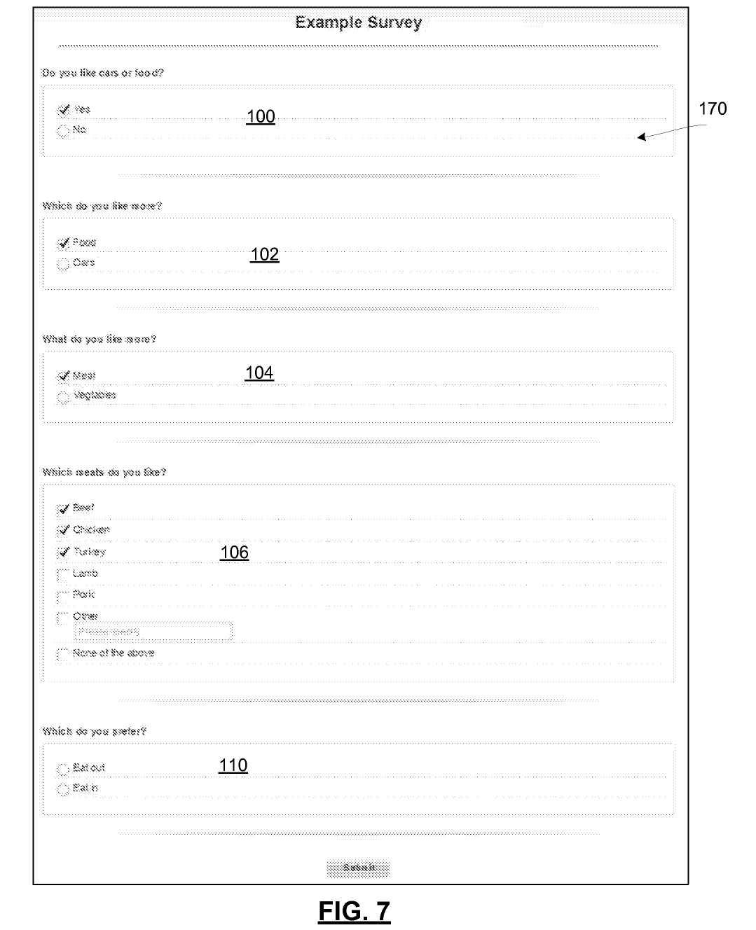

Referring additionally to the more detailed workings of the engines 66,68 in FIG. 4, at step 82 the rendering engine 66 renders hypertext markup (such as HTML) code for each survey question so that it is formatted for display by the browser 32. As illustrated, each question/answer set is formatted into a header 70, question text 72, any subtext 74, answer options 76, a footer 78 and a ‘widget’ container 80, which is a section where the output of more advanced applets are shown. (An example of the question format is shown in FIG. 7.) Of course, the question/answer format may be modified in practicing the invention and no format is preferred over any other. In the process of writing the hypertext, at step 84 the rendering engine 66 also links the question and/or displayed answer options with user interface events that will trigger or call a predetermined function (provided by common functions library). For example, when a user ticks off a checkbox with the mouse, the browser captures the UI event and control will pass to the function specified by this step. The output of the rendering engine 66 is the hypertext markup document 24.

The logic engine 68 creates the browser programming instructions 30, e.g., in javascript, that is associated with the hypertext markup document 24. In explaining the logic engine 68, it should be understood that each question in the survey may be associated with a plurality of states. The states are:
Answered—which may vary between ‘answered’ and ‘unanswered’ (or true and false). The ‘answered’ state indicates that the user has selected an answer for the question (or the system has pre-populated an answer), and the ‘unanswered’ state indicates that the user has not selected or provided an answer to the question.
Visible—which may vary between ‘shown’ and ‘hidden’ (or true and false). The ‘shown’ state indicates that the question should be/is shown by the browser, and the ‘hidden’ state indicates that the question should not be shown/is hidden by the browser.
Required—which may vary between ‘yes’ and ‘no’. The ‘yes’ state indicates that the question, if shown, must be answered to complete the survey.

Likewise, each answer option (where applicable) of each question may be associated with a plurality of states. These states are:
Selected—which may change state between ‘yes’ and ‘no’. The ‘yes’ state indicates that the answer option is selected, the ‘no’ state indicates that the answer option is not selected.
Enabled—A ‘true’ value indicates that the option answer is available for selection by the user, and a ‘false’ value indicates that the option answer is not available for selection by the user. (In practice, the Enabled state may be implemented by a variety of alternative boolean states depending on the question Type. For example, if the Type is a Radio, ‘select’/'deselect' states may be applied so that if one button is selected another box is deselected. Similarly, if the Type is a Checkbox, ‘enable’/'disable' states may be applied so that if one checkbox is selected other option answers and their associated boxes are grayed out and not available for selection.)

The logic engine 68 retrieves survey questions from the question base 18 in QID order and writes javascript code, exemplified at 89, into the programming file 30 corresponding to the logic functions identified in the Question_Logic 50, Selected_Logic 56 and Not Selected_Logic fields 50, 56 and 58. Generally speaking, these logic functions will validate answers and embody basic survey branching logic. Thus, for example, at step 86 the logic engine 68 inserts javascript code in the programming file 30 to run a ‘Verify’ function based on the question type whenever the user selects any answer option. In addition, at step 88 , the logic engine 68 inserts javascript code into the programming file 30 to run a ‘ShowQuestion’ function in order to display another question if the user selects a particular answer option, or a ‘HideQuestion’ function in order to hide another question if the user does not select the particular answer option. As discussed in greater detail below these functions may be recursive in nature which enables a whole series or chain of questions to be dealt with at once and enables large chunks from one survey to be quickly and easily re-used in another survey.

These logic fields 50, 56 and 58 may also point to more advanced applets or micro-programs provided by widget store 92.

The javascript code for the programming file 30 is rendered on the fly in response to the question records retrieved from the question base 18. The logic fields 50, 56, 58 may reference functions stored in common function library 90 and may call applets or micro-programs stored in widget store 92. If desired, the logic fields 50, 56, and 58 may also include explicit javascript code which is written into the programming file.

In the process of retrieving a question from the question base 18, a logic field 50, 56, 58 may contain a reference to other questions as a parameter to the functions. In the illustrated example of FIG. 4, for instance, the functions ShowQuestion( )and HideQuestion( )point to other questions QID₂ and QID₃. These references may be parsed by the logic engine and placed on a stack or other such data structure and the referenced QIDs used to retrieve records from the question base 18 for processing by the rendering and logic engines 66, 68.

At step 96 (FIG. 3) the HTML file 24 rendered by the rendering engine 66, the javascript file rendered by the logic engine 68, and other resources from libraries 90, 92, 94 are collected and transmitted to the user as web page files 24, 26, 30 and 32 representing survey 22.

Once received, the client browser displays and executes the survey 22. As it is served all at once with branching logic intact, there is no need to repeatedly serve additional web pages to the client and data transfer can be minimized to the server while survey answers captured in a data array can be periodically communicated to the server as a caching mechanism via Ajax posts.

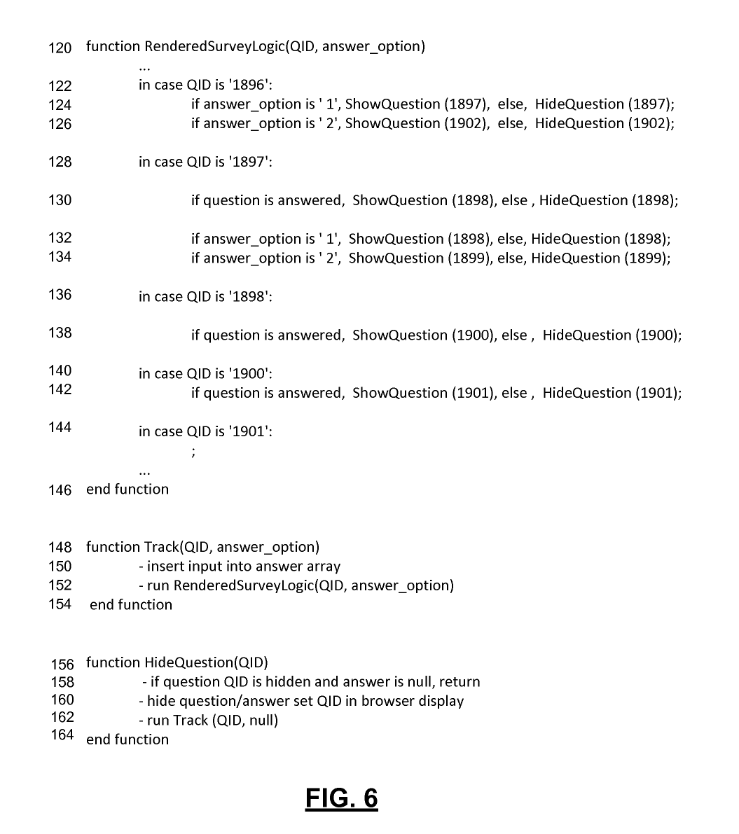

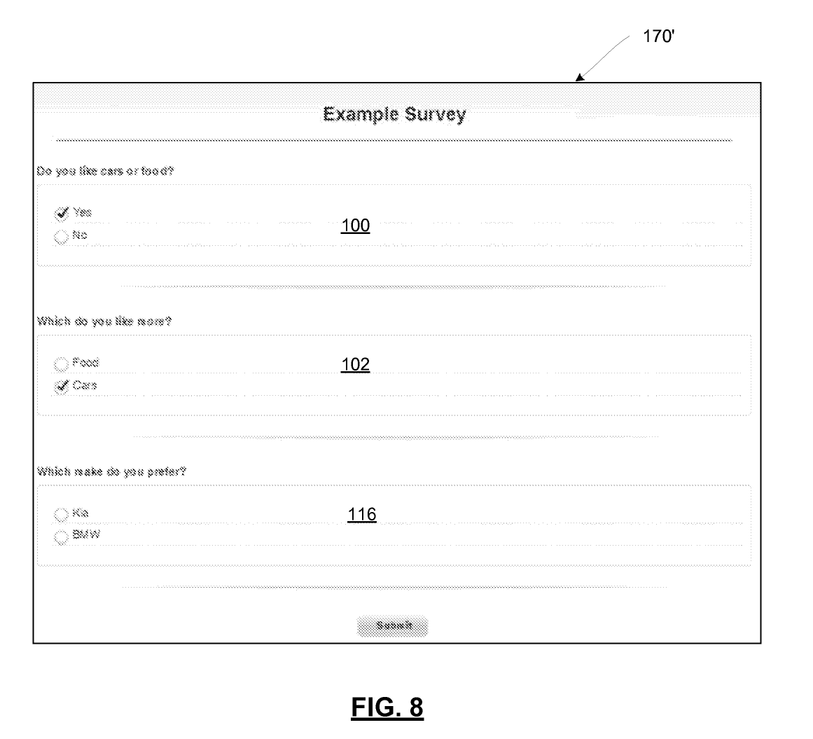

The robustness of the system 10 can be appreciated by considering an example survey represented by the survey logic schematic diagram shown in FIG. 5, partial survey logic pseudo code shown in FIG. 6, and browser display screens shown in FIGS. 7 and 8.

The survey logic schematic diagram shown in FIG. 5 represents the contents of a question base 18′, including links or pointers to other questions invoked through the logic fields 50, 56, 58, which links are represented in FIG. 5 by the connecting lines. Thus, for example, when the user is at question #1896 (ref no. 102) and selects the ‘food’ answer option, then the next question displayed should be question #1897 (ref no. 104). On the other hand if the user selects the ‘cars’ answer option then the next question displayed should be question #1902 (ref no. 116).

FIG. 6 shows a portion of the programming code, in pseudo code form, that is written by the logic engine 68 to reflect the branching logic embedded in the question base 18′. The RenderedSurveyLogic function commencing at line 120 is rendered by the logic engine. The Track and HideQuestion functions commencing at lines 148 and 156 are predetermined functions provided in library 90.

FIG. 7 shows the browser display window 170 after the user has traversed a portion the left side of the survey logic schematic diagram shown in FIG. 5, along path 100, 102, 104, 106, 110. All these questions are displayed in the browser window 170.

Now, suppose that the user returns to question #1896 (ref. no. 102) and changes the answer to ‘cars’. The remaining questions should no longer be displayed because they are no longer relevant. The question base 18′ and corresponding pseudo code reflect such branching logic. More particularly, when the user selects ‘car’ for question #1896 (ref. no 102) the hypertext markup document (not shown for this example) will recognize this user interface event and pass control to the Track function at line 148. At line 150, the answer data array is updated so that QID #1896 has value ‘2’ to reflect the newly selected answer option of ‘cars’. Line 152 then calls the RenderedSurveyLogic function at line 120 rendered by the logic engine. Control passes to line 122 relating to question #1896 . Line 124 is executed because the answer option is ‘2’, so the HideQuestion function is called with QID #1897 passed as the argument. Control passes to the HideQuestion function at line 156. Line 156 is false because QID #1897 has a non-null value and is visible. Consequently line 158 hides question #1897 (ref. no 104) (this can be accomplished by changing a form row to not visible). At line 162 the Track function is once again called, but this time the arguments are QID #1897 and a null value. This mimics a user response, but at line 150 the Track function basically removes any value that question #1897 had. (Based on the state of the survey as shown in FIG. 7, question #1897 previously had the ‘1’ value corresponding to the ‘meat’ answer option.) The Track function once again calls the RenderedSurveyLogic function at line 120 with argument QID #1897 and a null value. Now control passes to the case at line 128, and more particularly to the condition at line 130. Question #1897 has a non-answered state (because QID #1897 has no value) so the HideQuestion function is called with argument QID #1898 . Once again the HideQuestion function sets the display state of question #1898 to not visible and calls the Track function to set QID #1898 to null in the answer data array. In turn, the Track function once again calls the RenderedSurveyLogic function. The recursive traversal continues at line 138 to hide question #1900 , then line 142 to hide question #1901 (which was not visible/answered in any event) and then finally to line 144 where the recursive traversal ends.

Control ultimately returns to line 126 where the answer option to QID #1896 is ‘2’ (representing ‘cars’), following which the ShowQuestion function is called which displays question #1902 (ref. no. 116).

Thus, as a consequence of changing the answer to ‘cars’ from ‘food’ in question #1896 (ref. no. 102), questions #1897, #1898, and #1900 . (ref nos. 104, 106 and 110) are cleared in the data answer array and removed from view as seen in the browser display screen 170′ of FIG. 8.

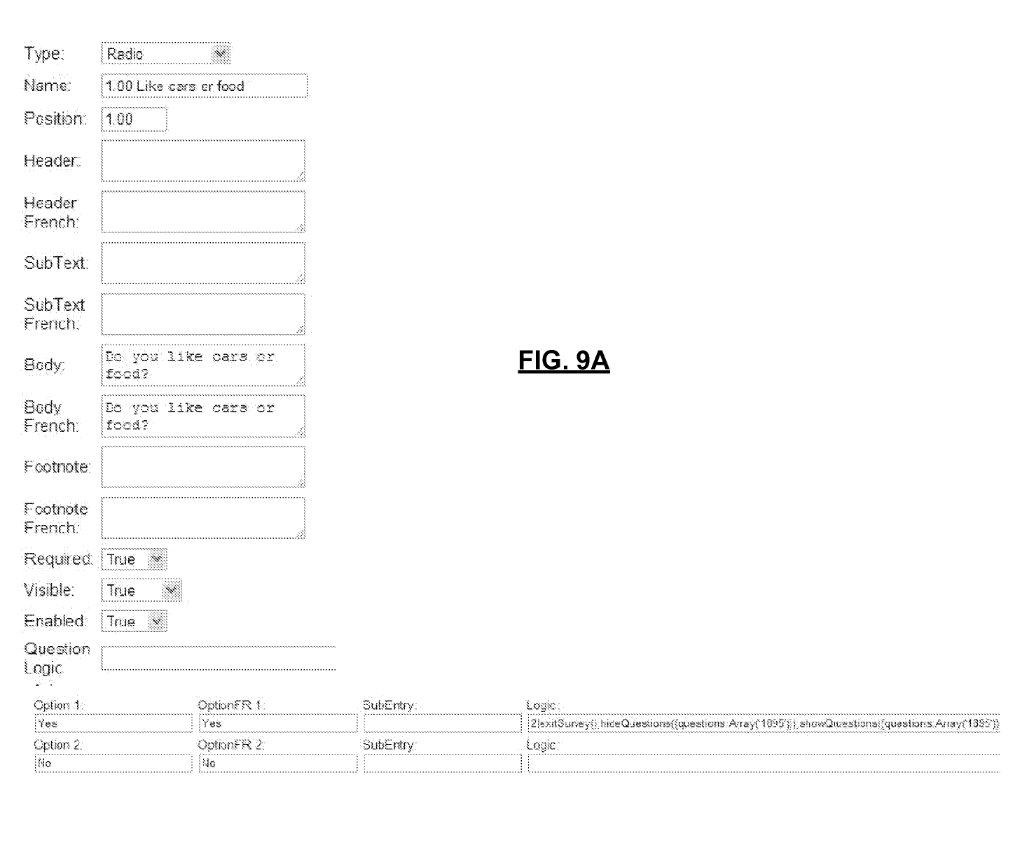

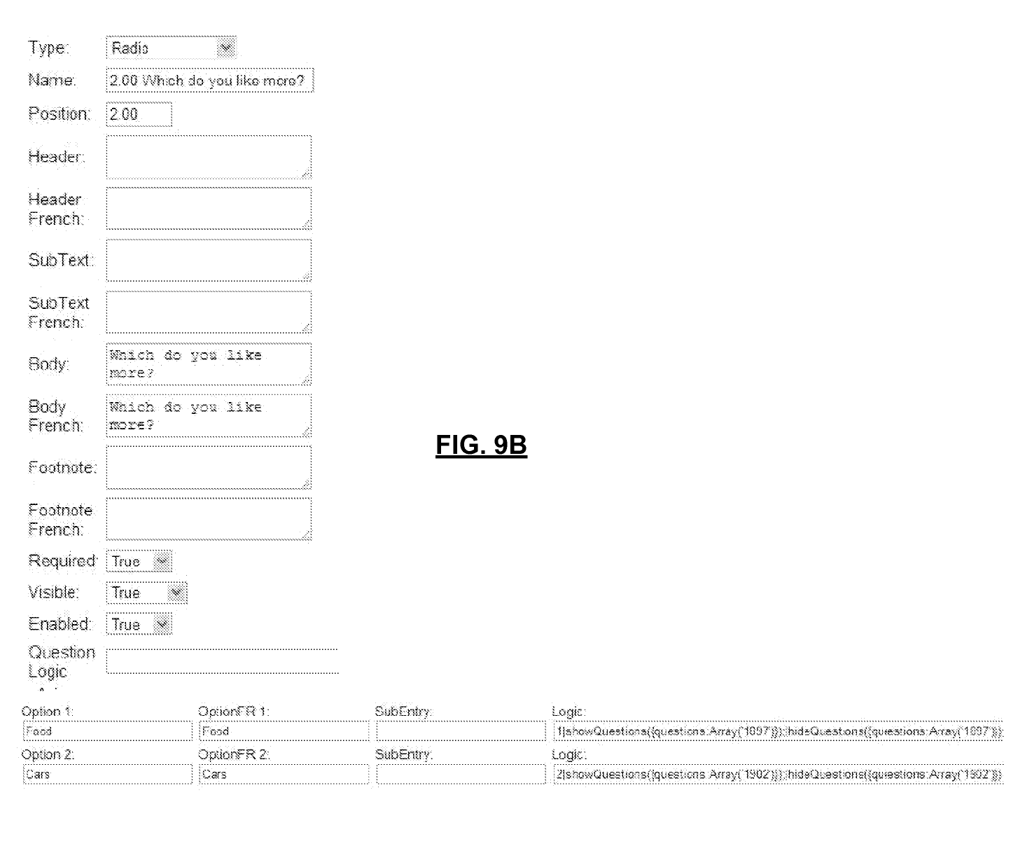

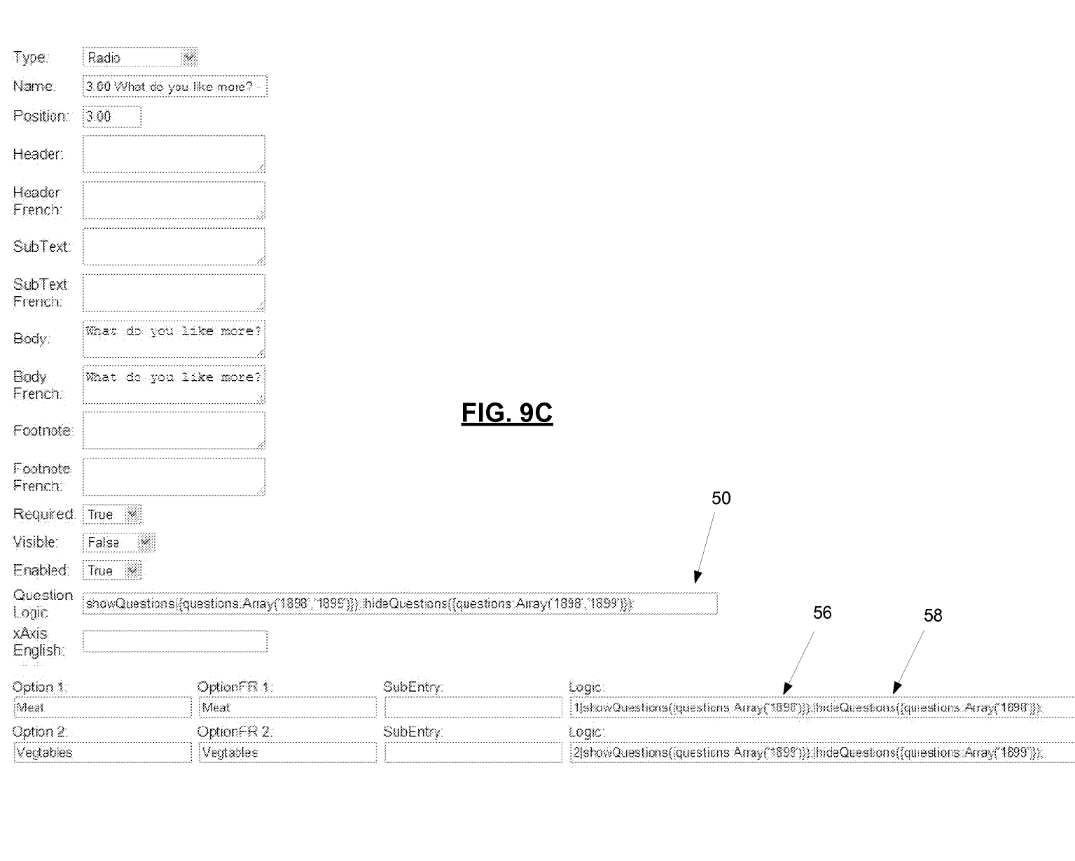

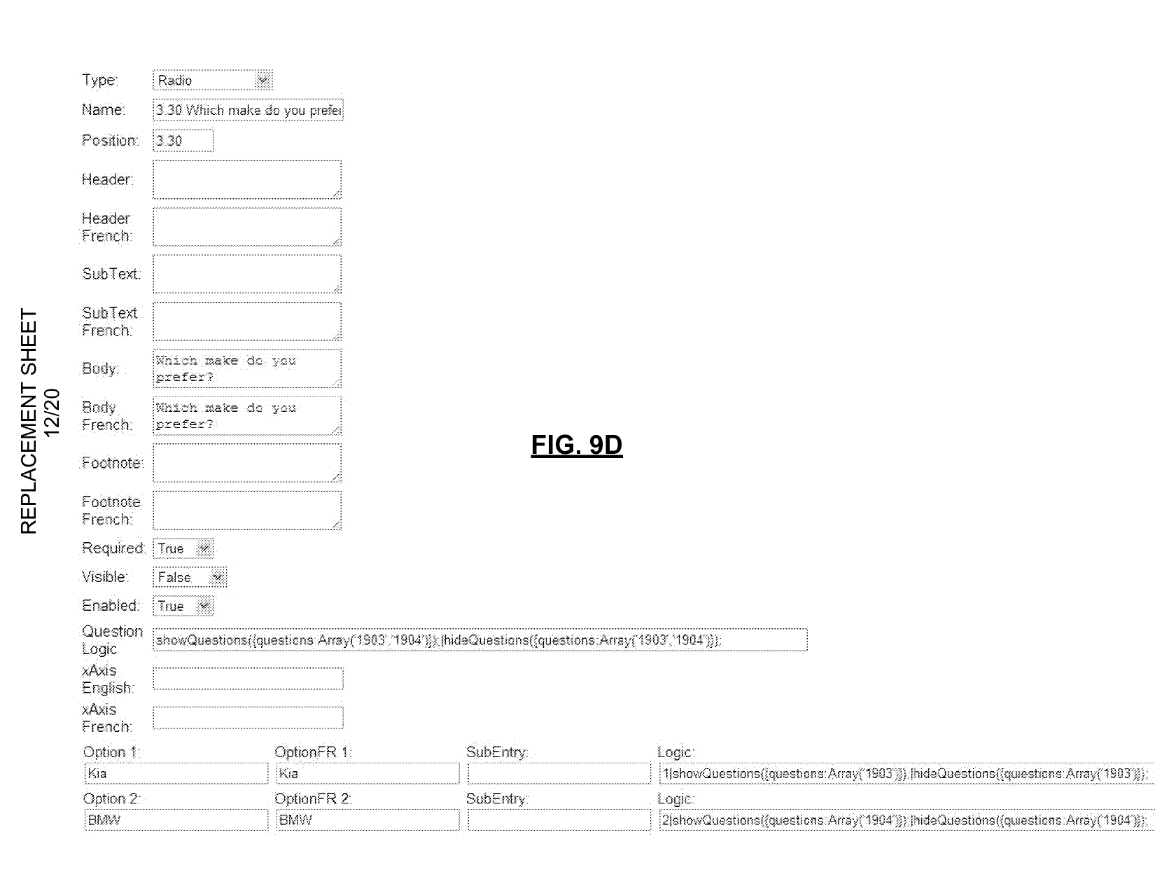

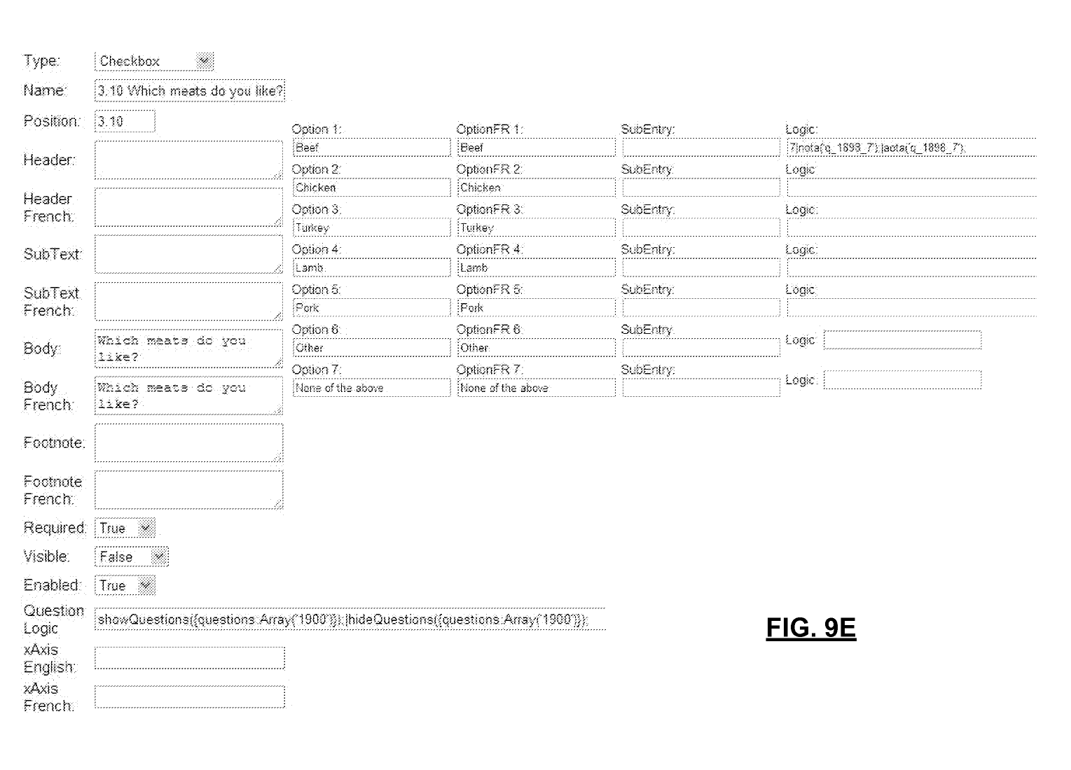

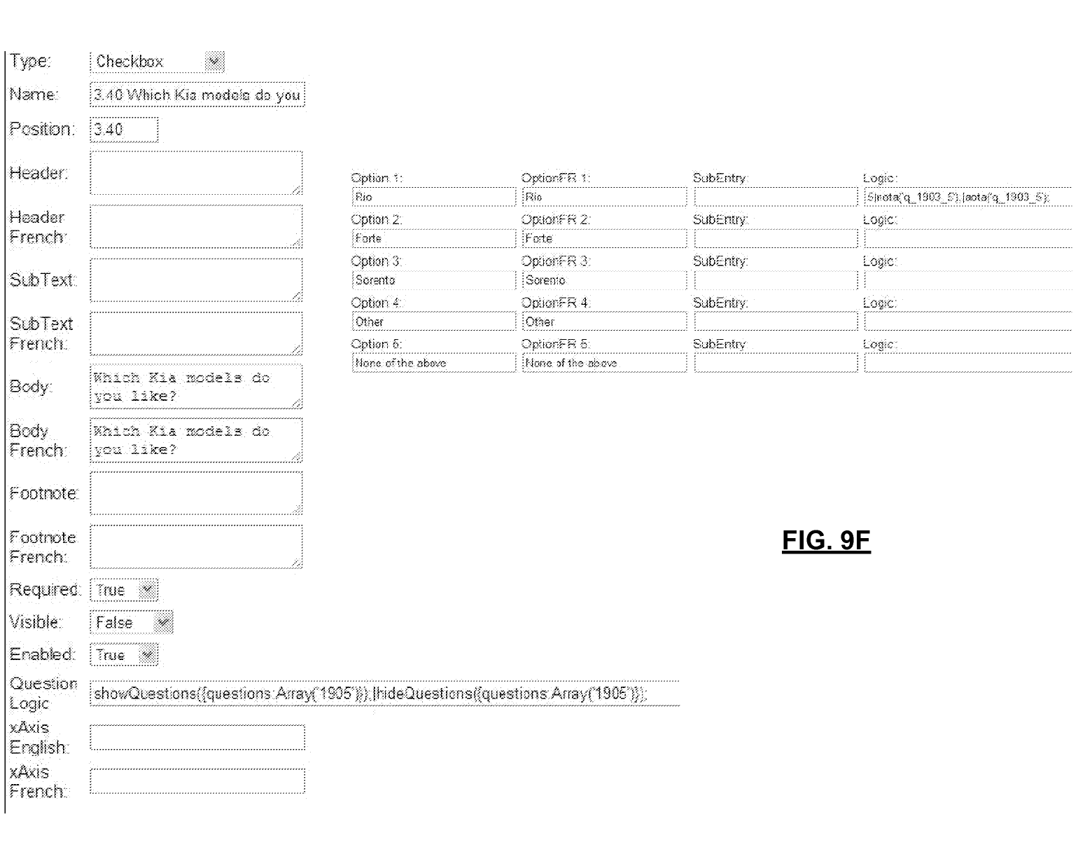

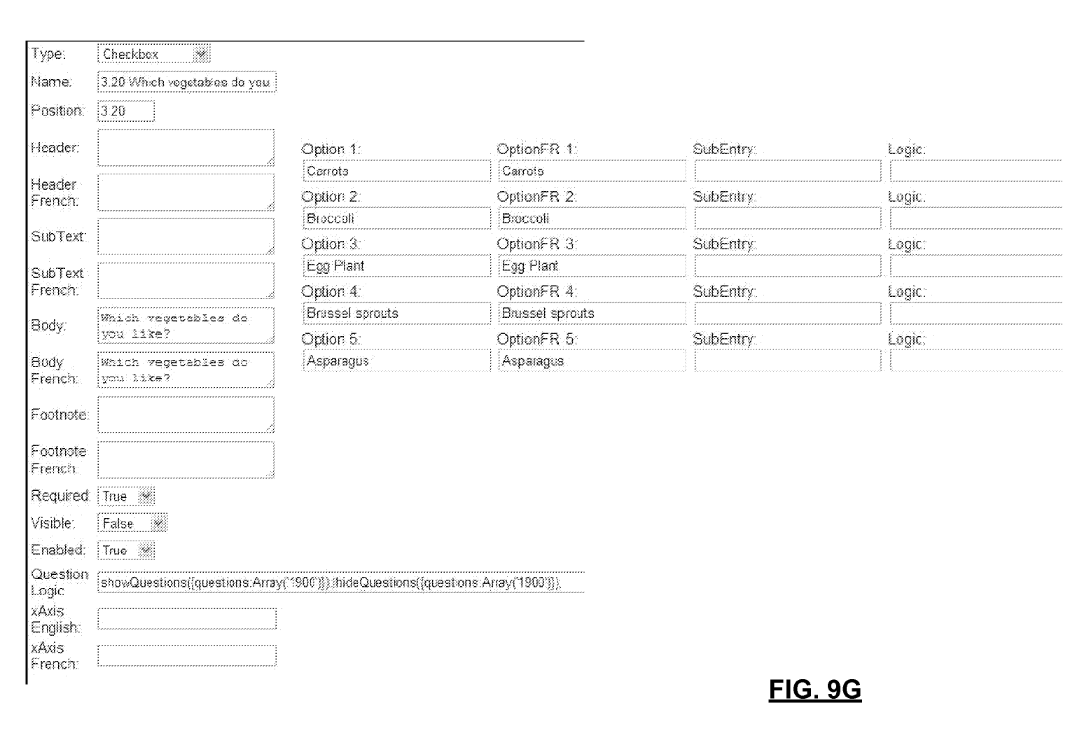

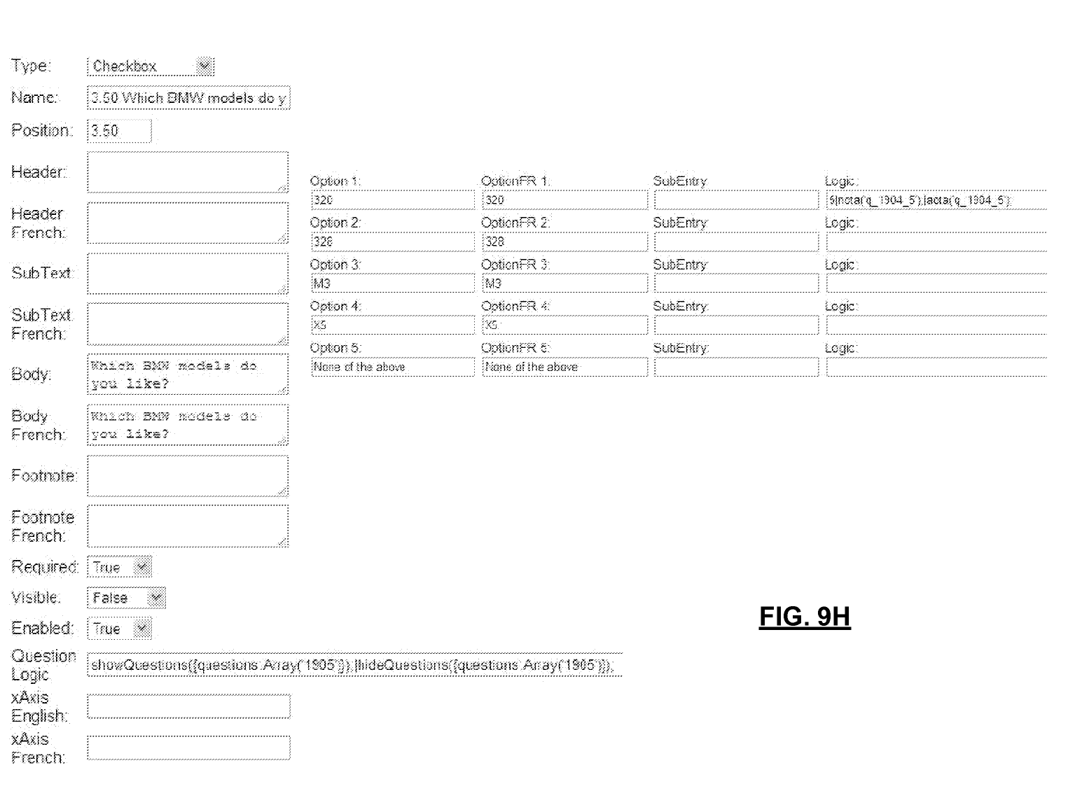

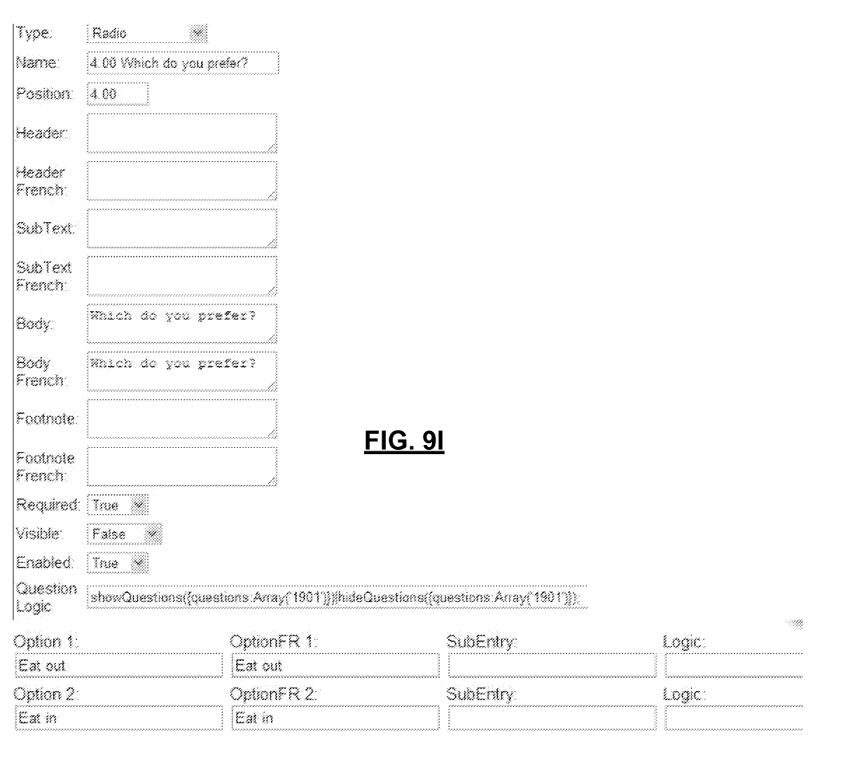

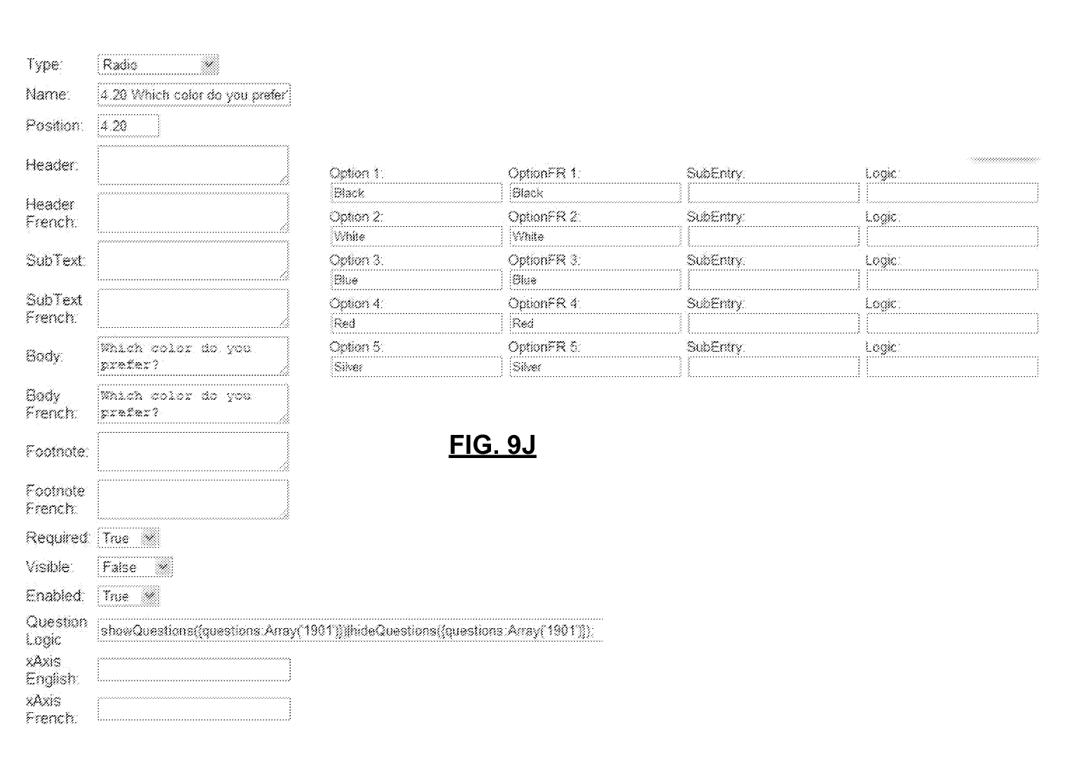

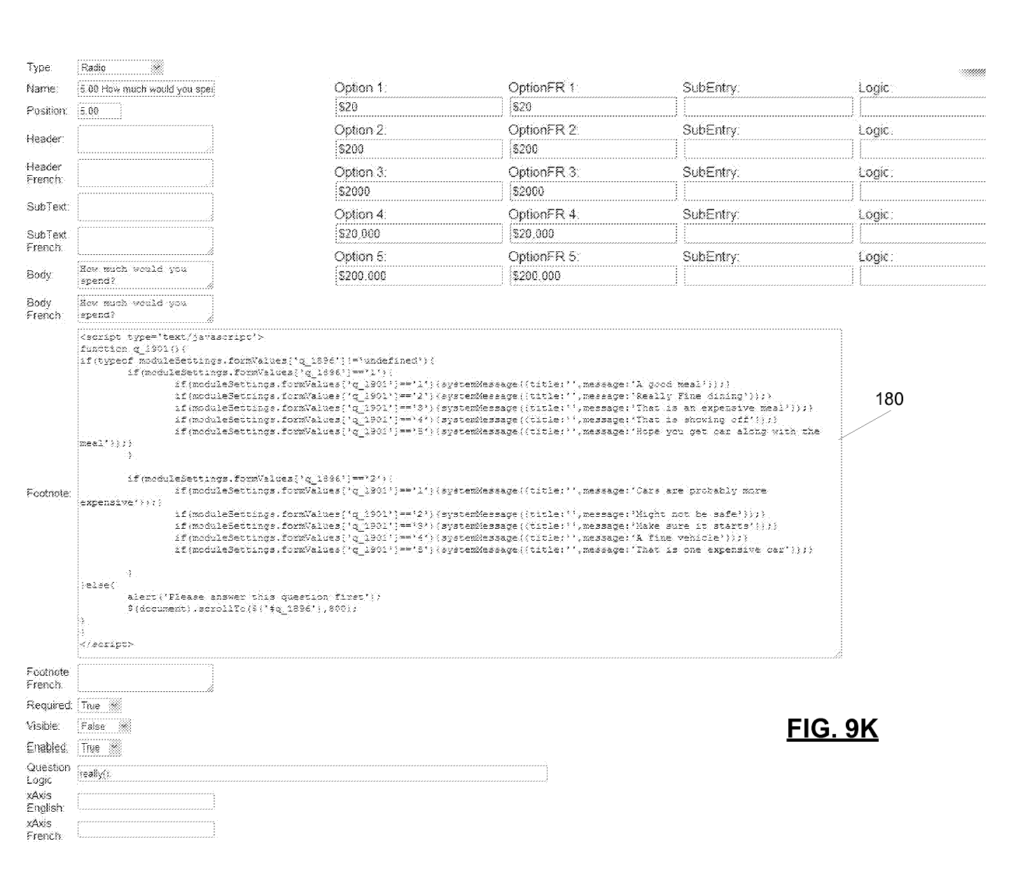

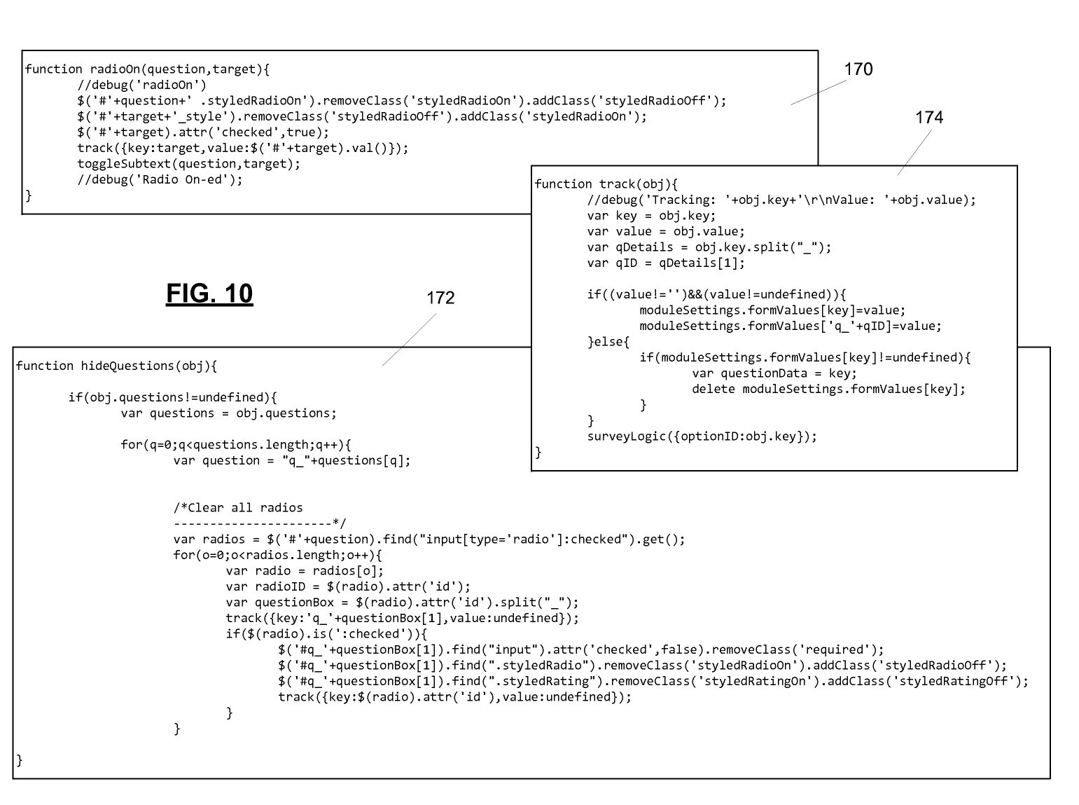

FIGS. 9A-9K show a portion of a question base that reflects the example survey depicted in FIG. 5. The computer program listing and FIG. 10 show portions of javascript code for implementing the example survey. The computer program listing shows the survey logic rendered by the rendering program 20, identified as the surveyLogic function. The rendering program 20 writes expressions such as (moduleSettings.formValues[‘q_{—}1896 ’]!undefined && (moduleSettings.formValues[‘q_{—}1896 ’]==‘1’) based on the Selected_Logic and Not_Selected_Logic fields 56 and 58 associated with the answer option logic. (See FIG. 9C). The rendering program 20 writes an expression such as typeof moduleSettings.formValues[obj.optionID]!= ‘undefined’ based on the Question_Logic field 50. Also note that the showQuestions and hideQuestions functions can operate on multiple arguments. FIG. 10 shows a radioOn function 170, which the HTML text calls in response to a user interface event associated with a radio button list; a hideQuestions function 172 which operates similar to that described in FIG. 6 and a track function 174 which also operates similar to that shown in FIG. 6. Note that the survey logic function shown in FIG. 10 calls the hideQuestions function 172, which calls the track function 174, which calls the surveyLogic function of FIG. 10, thus providing the recursive chain described previously.

In addition, as can be seen from FIG. 9K, the rendering program 20 may write more complex functions. In this example a Footnote field 180 in the question base holds explicit javascript code, or may alternatively reference a pre-defined function. The code looks at the path selected by the user based on the answer to question #1896 (ref. no. 102) and the answer selected by the user for question #1901 (ref. no 112) and opens a window with a suitable message as seen in the drawing.

While the logic shown in the previous examples is related to question branching logic, the functions called may also selectively enable/disable answer options associated with a specific question. For example, in a five-box checkbox selecting boxes 1 and 2 may disable boxes 3-5. Thus, the question base could store a function in the Selected_Logic and Not Selected_Logic fields 56, 58 which handles such a situation and can be rendered by the logic engine 68 to provide appropriate code for execution by the browser.

From the foregoing it should be appreciated that the survey system 10 is efficient in that it enables the survey designer to rapidly reuse portions of existing surveys via the simple linkage of merely referencing the top of question sub-tree. The rendering program handles the rest, eliminating the need to hand code changes to branching logic from survey to survey. In addition, as the survey is served in its entirety to the client with branching logics intact, there is no need for page refreshes to the server and to the user, especially one who is using a limited bandwidth device such as a smartphone, the experience is smooth and fast.

Those skilled in the art will understand that a variety of modifications may be made to the specific examples and embodiments described herein in order to achieve the same or similar functionality. For example, while the above described embodiments have shown a recursive logic chain in connection with hiding multiple questions or enabling/disabling answer options, the same can be utilized for showing multiple questions or for a combination of showing or hiding, or for any other feature such as algorithms/calculations, advanced validation, simulations, interactive cases/stories, presentations and knowledge testing. In addition, while the above described embodiments have segmented the markup document, style sheets, images, survey browser programming instructions and pre-defined functions in separate files, those skilled in the art will appreciate that these elements may be served in a single file or may be mixed and matched in various permutations and combinations in various files or through different logic flow. Similarly other modifications may be made without departing from the scope of the accompanying claims.

### COMPUTER PROGRAM LISTING

<script type=‘text/javascript’>
busy({state:true,text:‘Loading logics’});
/* Survey Logics
----------------------------------*/
function surveyLogic(obj){

var target = obj.optionID;
var data = obj.optionID.split(“_”);
var details = {

questionID:data[1],
option:data[2],
element:data[3]

}
//summaryAdd({details:details});
if(eval(“typeof q_”+details.questionID+“”)==‘function’){

debug(‘Running function: q_’+details.questionID+‘( )’);
eval(“q_”+details.questionID+“( )”);

}
switch(details.questionID){

case“1895”:

//***Type: radio***//
if( (moduleSettings.formValues[‘q_1895’]!=undefined) &&

(moduleSettings.formValues[‘q_1895’]==‘2’) ){

exitSurvey( );
hideQuestions({questions:Array(‘1895’)});
showQuestions({questions:Array(‘1895’)});

}else{
}

break;

case“1896”:
//***Type: radio***//
if( (moduleSettings.formValues[‘q_1896’]!=undefined) &&

(moduleSettings.formValues[‘q_1896’]==‘1’) ){

showQuestions({questions:Array(‘1897’)});

}else{

hideQuestions({questions:Array(‘1897’)});

}
if( (moduleSettings.formValues[‘q_1896’]!=undefined) &&

(moduleSettings.formValues[‘q_1896’]==‘2’) ){

showQuestions({questions:Array(‘1902’)});

}else{

hideQuestions({questions:Array(‘1902’)})

}

break;
case“1897”:

//***Type: radio***//
if(typeof moduleSettings.formValues[obj.optionID]!=‘undefined’){

showQuestions({questions:Array(‘1898’)});

}else{

hideQuestions({questions:Array(‘1898’)});

}
if( (moduleSettings.formValues[‘q_1897’]!=undefined) &&

(moduleSettings.formValues[‘q_1897’]==‘1’) ){

showQuestions({questions:Array(‘1898’)});

}else{

hideQuestions({questions:Array(‘1898’)});

}
if( (moduleSettings.formValues[‘q_1897’]!=undefined) &&

(moduleSettings.formValues[‘q_1897’]==‘2’) ){

showQuestions({questions:Array(‘1899’)});

}else{

hideQuestions({questions:Array(‘1899’)});

}

break;
case“1898”:

//***Type: checkbox***//
if(typeof moduleSettings.formValues[obj.optionID]!=‘undefined’){

showQuestions({questions:Array(‘1900’)});

}else{

hideQuestions({questions:Array(‘1900’)});

}
if( (moduleSettings.formValues[‘q_1898’]!=undefined) &&

(in_array(7,moduleSettings.formValues[‘q_1898’]))){

nota(‘q_1898_7’);

}else{

aota(‘q_1898_7’);

}

break;
case“1899”:

//***Type: checkbox***//
if(typeof moduleSettings.formValues[obj.optionID]!=‘undefined’){

showQuestions({questions:Array(‘1900’)});

}else{

hideQuestions({questions:Array(‘1900’)});

}

break;
case“1902”:

//***Type: radio***//
if(typeof moduleSettings.formValues[obj.optionID]!=‘undefined’){

showQuestions({questions:Array(‘1903’)});

}else{

hideQuestions({questions:Array(‘1903’)});

}
if( (moduleSettings.formValues[‘q_1902’]!=undefined) &&

(moduleSettings.formValues[‘q_1902’]==‘1’) ){

showQuestions({questions:Array(‘1903’)});

}else{

hideQuestions({questions:Array(‘1903’)});

}
if( (moduleSettings.formValues[‘q_1902’]!=undefined) &&

(moduleSettings.formValues[‘q_1902’]==‘2’) ){

showQuestions({questions:Array(‘1904’)});

}else{

hideQuestions({questions:Array(‘1904’)});

}

break;
case“1903”:

//***Type: checkbox***//
if(typeof moduleSettings.formValues[obj.optionID]!=‘undefined’){

showQuestions({questions:Array(‘1905’)});

}else{

hideQuestions({questions:Array(‘1905’)});

}
if( (moduleSettings.formValues[‘q_1903’]!=undefined) &&

(in_array(5,moduleSettings.formValues[‘q_1903’]))){

nota(‘q_1903_5’);

}else{

aota(‘q_1903_5’);

}

break;
case“1904”:

//***Type: checkbox***//
if(typeof moduleSettings.formValues[obj.optionID]!=‘undefined’){

showQuestions({questions:Array(‘1905’)});

}else{

hideQuestions({questions:Array(‘1905’)});

}
if( (moduleSettings.formValues[‘q_1904’]!=undefined) &&

(in_array(5,moduleSettings.formValues[‘q_1904’]))){

nota(‘q_1904_5’);

}else{

aota(‘q_1904_5’);

}

break;
case“1900”:

//***Type: radio***//
if(typeof moduleSettings.formValues[obj.optionID]!=‘undefined’){

showQuestions({questions:Array(‘1901’)})

}else{

hideQuestions({questions:Array(‘1901’)});
}

break;
case“1905”:

//***Type: radio***//
if(typeof moduleSettings.formValues[obj.optionID]!=‘undefined’){

showQuestions({questions:Array(‘1901’)})

}else{

hideQuestions({questions:Array(‘1901’)});

}

break;
case“1901”:

//***Type: radio***//

break;
default:

//debug(‘No logic for: ’+target);

break;

}

}
$(document).ready(function( ){
/* Load Previous Answers
------------------*/

loaderMessage(“Checking for answers”);
busy({state:true,text:‘Fetching...’});
//if( (sessionInfo.userInfo.type!=‘staff’) && (!debugging) ){

actionRequest({

settings:

{customLogic:moduleSettings.customLogic,installPath:moduleSettings.installPath,surveyInfo:mo
duleSettings.surveyInfo},

action: ‘loadAnswers’,
userID: sessionInfo.userInfo.userID,
surveyID:

sessionInfo.program.info.flow[sessionInfo.program.flowInfo.current].surveyID

});

//}else{

//busy({state:false});
//$(‘#surveyLoader’).fadeOut(‘slow’);

//}

});
</script>

1. A method of conducting an on-line survey having multiple questions, the method comprising:
provisioning a server and at least one client device connectable over a communications network;
maintaining a question database, the database including questions records, wherein each question record includes a question text field, a question type field, at least one answer field, and at least one logic field, wherein at least a subset of the logic fields in the questions records has or references at least one first logic function;
receiving a request to conduct an on-line survey and retrieving a plurality of the question records from the question database;
generating a markup document, corresponding to the information in the retrieved question records, for displaying the survey questions and at least one user answer input per question in a browser, the markup document calling survey logic browser programming instructions in response to user input events;
generating the survey logic browser programming instructions based on the at least one logic field from the retrieved question records;
organizing the question database so that, when generated, the survey logic browser programming instructions associated with a first given question call the at least one first logic function in association with a second given question, wherein the at least one first logic function directly or indirectly calls the survey logic browser programming instructions in association with the second given question so as to provide a recursive logic chain at least two levels deep;
serving the markup document, the survey logic browser programming instructions and the at least first logic function to a client device; and
displaying the markup document via a client device browser, wherein, in execution, the survey logic browser programming instructions associated with the first given question call the at least one first logic function in association with the second given question, wherein the at least one first logic function directly or indirectly calls the survey logic browser programming instructions in association with the second given question so as to provide a recursive logic chain at least two levels deep.

2. A method according to claim 1, wherein the, step of organizing the question database occurs prior to the steps of generating the markup document and generating the survey logic browser programming instructions.

3. A method according to claim 1, wherein the steps of generating the markup document and generating the survey logic browser programming instructions are carried out by the server.

4. A method according to claim 3, wherein serving the markup document and the survey logic browser programming instructions at substantially one time to the client device so as to eliminate requirement for browser page refreshes.

5. A method according to claim 3, wherein the question record includes a survey identifier field and the server retrieves question records from the question database based on a survey identifier transmitted by the client device in the request to conduct the on-line survey.

5. A method according to claim 3, wherein, in retrieving question records from the question database, the server also retrieves additional question records based on question associations in the logic functions stored in the at least one question record logic field.

6. A method according to claim 1, wherein each question record has at least one logic field associated with the question as a whole and at least one logic field associated with each answer field of each question record.

7. A method according to claim 6, wherein the at least one first logic function is responsible for hiding or removing a question from the visible browser display, and wherein the recursive logic chain hides a plurality of visible questions from the browser display when the user changes an answer to a question.

8. A method according to claim 6, wherein the at least one first logic function is responsible for showing an additional question on the browser display, and wherein the recursive logic chain shows additional questions on the browser display when the user changes an answer to a question.

9. A method according to claim 1, wherein the at least one first logic function calls at least one other logic function which calls the survey logic browser programming instructions.

10. A system for conducting an on-line survey having multiple questions, the system comprising:
a server;
at least one client device connectable to the server via a communications network;
a question database accessible by the server, the database including questions records, wherein each question record includes a question text field, a question type field, at least one answer field, and at least one logic field, wherein at least a subset of the logic fields in the questions records has or references at least one first logic function;
wherein the server, in response to the client device sending a request to conduct an on-line survey, is programmed to (i) retrieve a plurality of the question records from the question database, (ii) generate a markup document, corresponding to the information in the retrieved question records, for displaying the survey questions and at least one user answer input per question in a browser, the markup document being configured to call survey logic browser programming instructions in response to user input events, (iii) generate the survey logic browser programming instructions based on the at least one logic field from the retrieved question records; and (iv) serve the markup document, the survey logic browser programming instructions and the at least first logic function to the at least one client device;
wherein the question database is organized such that, when generated, the survey logic browser programming instructions associated with a first given question call the at least one first logic function in association with a second given question, wherein the at least one first logic function directly or indirectly calls the survey logic browser programming instructions in association with the second given question so as to provide a recursive logic chain at least two levels deep;
wherein the client device displays the markup document via a client device browser, wherein, in execution, the survey logic browser programming instructions associated with the first given question call the at least one first logic function in association with the second given question, wherein the at least one first logic function directly or indirectly calls the survey logic browser programming instructions in association with the second given question so as to provide a recursive logic chain at least two levels deep.

11. A system according to claim 10, wherein the server serves the markup document and the survey logic browser programming instructions at substantially one time to a given client device so as to eliminate requirement for browser page refreshes.

12. A system according to claim 10, wherein the question record includes a survey identifier field and the server retrieves question records from the question database based on a survey identifier transmitted by the client device in the request to conduct the on-line survey.

13. A system according to claim 12, wherein, in retrieving question records from the question database, the server also retrieves additional question records based on question associations in the logic functions stored in the at least one question record logic field.

14. A system according to claim 10, wherein each question record has at least one logic field associated with the question as a whole and at least one logic field associated with each answer field of each question record.

15. A system according to claim 10, wherein the at least one first logic function is responsible for hiding or removing a question from the visible browser display, and wherein the recursive logic chain hides a plurality of visible questions from the browser display when the user changes an answer to a question.

16. A system according to claim 10, wherein the at least one first logic function is responsible for showing an additional question on the browser display, and wherein the recursive logic chain shows additional questions on the browser display when the user changes an answer to a question.

17. A system according to claim 10, wherein the at least one first logic function calls at least one other logic function which calls the survey logic browser programming instructions.

18. A system according to claim 10, wherein the at least one first logic function processes user answers to a number of questions and generates a visible output based on the answers.

19. A computer program product for creating an electronic survey, the computer program product being stored on a computer readable storage device and configured to cause a computer server system to:
receive a request to conduct an on-line survey and retrieve a plurality of question records from a question database, wherein the database includes questions records, wherein each question record includes a question text field, a question type field, at least one answer field, and at least one logic field, wherein at least a subset of the logic fields in the questions records has or references at least one first logic function;
generate a markup document, corresponding to the information in the retrieved question records, for displaying the survey questions and at least one user answer input per question in a client browser, the markup document calling survey logic browser programming instructions in response to user input events;
generate the survey logic browser programming instructions based on the at least one logic field from the retrieved question records;
organize the question database so that, when generated, the survey logic browser programming instructions associated with a first given question call the at least one first logic function in association with a second given question, wherein the at least one first logic function directly or indirectly calls the survey logic browser programming instructions in association with the second given question so as to provide a recursive logic chain at least two levels deep; and
serve the markup document, the survey logic browser programming instructions and the at least first logic function to a client device.
